(19) United States
(12) Patent Application Publication
(10) Pub. No.: US 2023/0314756 A1
(43) Pub. Date: Oct. 5, 2023

(54) CAMERA DEVICE AND PORTABLE ELECTRONIC DEVICE

(71) Applicant: AAC Optics (Nanning) Co., Ltd., Nanning City (CN)

(72) Inventor: Takashi Iwasaki, OSAKA (JP)

(21) Appl. No.: 17/829,390

(22) Filed: Jun. 1, 2022

(30) Foreign Application Priority Data
Mar. 31, 2022 (JP) 2022-060628

(51) Int. Cl. G02B 7/08; G03B 13/36

(52) U.S. Cl. CPC G02B 7/08; G03B 13/36

(57) ABSTRACT

Provided are a camera device and a portable electronic device. The drive magnet is arranged closer to the optical axis, and the drive coil is arranged between a closed magnetic circuit formed by the drive magnet and a case. In this case, there is no need to provide a yoke at the case, and a gap between the drive magnet and the drive coil can be made closer, thereby improving the driving force of the automatic focusing mechanism and reducing a volume of the drive element of the automatic focusing mechanism. Meanwhile, it can prevent the movable part from contacting a surface of the magnet, thereby improving the dust-proof performance. In addition, by making the drive coil, which serves as a heat source, move away from the lens, degradation of the lens performance caused by heat can be alleviated.

### TECHNICAL FIELD

The present invention relates to the technical field of camera devices, in particular to a camera device and a portable electronic device.

### BACKGROUND

With development of photographing technology, camera devices including lens driver are widely used in various photographic devices. The application of the camera device including the lens drive to various portable electronic devices, such as cellphones, tablet computers, etc., is especially accepted by consumers.

The driving mechanism of the lens drive of the portable electronic device in the related art is generally provided with an automatic focusing mechanism for adjusting the focus in a direction of an optical axis. However, for example, the autofocus mechanism installed in a small and compact device such as a portable electronic device, such as a mid-telephoto optical system with a long optical length, requires an increase in the driving force and the weight of the lens to accommodate a larger camera element unit. In addition, in order to provide a lens position detection element, a shape of a driving magnet will be limited. Furthermore, in addition to the difficulty in reducing the height and size of the device, it is also difficult to avoid shock and dust when the device is dropped. In addition, in order to deal with the enlargement of the camera element unit, the lens also tends to have a large size, indicating that a drive source of the autofocus mechanism shall be smaller in size, lower in height, and have a larger driving force.

Therefore, it needs to provide a camera device and a portable electronic device to solve the above problems.

### SUMMARY

The present invention is intended to provide a camera device and a portable electronic device, aiming to solve the problem described above in the related art, which is a large volume and a low driving force of the drive element of the automatic focusing mechanism.

The technical scheme of the present invention is as follows.

In a first aspect, an embodiment of the present invention provides a camera device, including a lens having an optical axis; and an automatic focusing mechanism configured to drive the lens to move along a direction of an optical axis. The automatic focusing mechanism includes: a fixed part including a magnetic case for auto-focusing, at least one drive magnet for auto-focusing fixed to the case for auto-focusing, and a base for auto-focusing; a movable part including a lens holder, and a drive coil for auto-focusing fixed to the lens holder; and an elastic assembly that connects the fixed part and the movable part. A receiving space is formed by the case for auto-focusing and the base for auto-focusing, and the movable part is received in the receiving space. In a plane perpendicular to the optical axis, the drive magnet for auto-focusing is arranged at a side of the drive coil for auto-focusing close to the optical axis, and the drive coil for auto-focusing is arranged in a closed magnetic circuit formed by the at least one drive magnet for auto-focusing and the case for auto-focusing.

In an improved embodiment, the at least one drive magnet for auto-focusing includes four drive magnets for auto-focusing, the lens holder is provided with four through-holes penetrating along a direction parallel to the optical axis, and the four drive magnets for auto-focusing are received in the four through-holes.

In an improved embodiment, the camera device further includes a magnet holding frame for auto-focusing which is fixed to a side of the case for auto-focusing close to the base for auto-focusing. The at least one drive magnet for auto-focusing is fixed to the magnet holding frame for auto-focusing.

In an improved embodiment, the camera device further includes a yoke for auto-focusing provided at the base for auto-focusing. In a direction parallel to the optical axis, upper and lower ends of the at least one drive magnet for auto-focusing respectively abut against the magnet holding frame for auto-focusing and the yoke for auto-focusing.

In an improved embodiment, the case for automatic focusing is made of a magnetic material.

In an improved embodiment, the case for auto-focusing includes a case body and a case yoke attached to an inner side of the case body, and the case body is made of a non-magnetic material.

In an improved embodiment, the camera device further includes an enhancement yoke provided at a surface of the at least one drive magnet for auto-focusing close to the optical axis.

In an improved embodiment, one of the movable part and the fixed part is provided with a magnet for position detection for auto-focusing, and the other one of the movable part and the fixed part is provided with a Hall element for auto-focusing.

In an improved embodiment, the camera device further includes a driver IC. The driver

IC controls a position of the movable part.

In an improved embodiment, a distance between a side of the case for auto-focusing and a side of the lens holder is a first distance L1, and a distance between a side of the at least one drive magnet for auto-focusing and a side of the drive coil for the auto-focusing is a second distance L2 larger than the first distance L1.

In an improved embodiment, the camera device further includes a stabilization mechanism.

In an improved embodiment, the stabilization mechanism is arranged at an imaging side of the automatic focusing mechanism.

In a second aspect, an embodiment of the present invention provides a portable electronic device, including the camera device described above.

The technical scheme of the present invention has the following beneficial effects. The drive magnet for auto-focusing of the automatic focusing mechanism of the present invention is arranged closer to a center of the optical axis than the drive coil for auto-focusing, and the case for auto-focusing is a magnetic body, so that a closed magnetic circuit is formed between the case for auto-focusing by using the drive magnet. In this case, there is no need to provide a yoke inside the case for the auto-focusing, and a gap between the drive magnet for auto-focusing and the drive coil for auto-focusing can be made closer, thereby improving the driving force of the automatic focusing mechanism and reducing a volume of the drive element of the automatic focusing mechanism. Meanwhile, it can prevent the movable part from contacting a surface of the magnet for automatic focusing, thereby improving the dust-proof performance. In addition, by making the drive coil, which serves as a heat source, move away from the lens, degradation of the lens performance caused by heat can be alleviated.

In another method of arranging the drive magnet for auto-focusing closer to the center of the optical axis than the drive coil for auto-focusing, there is another moving magnet system in which the drive magnet for auto-focusing is fixed to the lens holder. However, this will further increase a weight of the movable part. Therefore, in order to ensure that the driving force of the automatic focusing mechanism is large enough to increase the volume of the drive element of the automatic focusing mechanism, the low-height, a small drive element of the automatic focusing mechanism is not suitable, and it is disadvantageous in terms of falling impact and positional stability.

Based on the above advantages, the present invention can achieve a more effective automatic focusing mechanism in the large-scale camera element unit, and improve the quality of a captured image.

### BRIEF DESCRIPTION OF DRAWINGS

FIG. 1 is a three-dimensional exploded view of an automatic focusing mechanism according to an embodiment of the present invention;

FIG. 2 is a side view of a camera device according to an embodiment of the present invention;

FIG. 3 is a three-dimensional view of a camera device in another direction according to an embodiment of the present invention;

FIG. 4 is a schematic diagram of a structure of a base for auto-focusing in FIG. 3;

FIG. 5 is a schematic diagram of a partial structure shown in FIG. 1;

FIG. 6 is a part of a cross-sectional view along an A-A direction of an automatic focusing mechanism in FIG. 2;

FIG. 7 is a part of a cross-sectional view along a B-B direction of an automatic focusing mechanism in FIG. 2;

FIG. 8 is a partial enlarged view of C shown in FIG. 7;

FIG. 9 is a schematic diagram of a closed magnetic circuit formed in an automatic focusing mechanism in FIG. 2;

FIG. 10 is a cross-sectional view of a partial structure of a camera device according to another embodiment of the present invention;

FIG. 11 is a cross-sectional view of a partial structure of a camera device according to still another embodiment of the present invention;

FIG. 12 is a three-dimensional exploded view of FIG. 3;

FIG. 13 is a top view of a stabilization mechanism and an FPC for the stabilization mechanism in FIG. 12;

FIG. 14 is a cross-sectional view of FIG. 3; and

FIG. 15 is a portable electronic device provided with a camera device according to an embodiment of the present invention.

### REFERENCE NUMERALS

1 . . . lens;
2 . . . camera element unit;
3 . . . optical axis;
10A . . . stabilization mechanism;
11 . . . yoke for the stabilization mechanism;
12 . . . movable frame for the stabilization mechanism;
13 . . . Hall element for the stabilization mechanism;
14 . . . coil for the stabilization mechanism;
15 . . . support component for the stabilization mechanism;
16 . . . support plate of support component for the stabilization mechanism;
17 . . . magnet for the stabilization mechanism;
18 . . . driver IC;
19 . . . FPC for the stabilization mechanism;
   191 . . . curved surface A of FPC for the stabilization mechanism;
   192 . . . curved surface B of FPC for the stabilization mechanism;
20 . . . base for the stabilization mechanism;
21 . . . vibration damping gel B for the stabilization mechanism;
22 . . . case for the stabilization mechanism;
23 . . . vibration damping gel A for the stabilization mechanism;
30A . . . automatic focusing mechanism;
31 . . . case for auto-focusing;
31′ . . . case for auto-focusing;
   311 . . . case body;
   312 . . . case yoke;
32 . . . magnet holding frame for auto-focusing;
33 . . . drive magnet for auto-focusing;
   33b . . . a side of the optical axis of the drive magnet for auto-focusing;
34 . . . yoke for auto-focusing;
35 . . . upper leaf spring for auto-focusing;
36 . . . lens holder;
   361 . . . through-hole;
37 . . . drive coil for auto-focusing;
38 . . . lower leaf spring for auto-focusing;
39 . . . FPC for auto-focusing;
40 . . . magnet for position detection for auto-focusing;
41 . . . Hall element for auto-focusing;
42 . . . anti-vibration gel for auto-focusing;
43 . . . base for auto-focusing;
44 . . . closed magnetic circuit;
45 . . . opening;
46 . . . receiving space;
47 . . . enhancement yoke;
100 . . . camera device;
200 . . . portable electronic device.

### DETAILED DESCRIPTION OF EMBODIMENTS

The present invention will be further described below with reference to the accompanying drawings and embodiments.

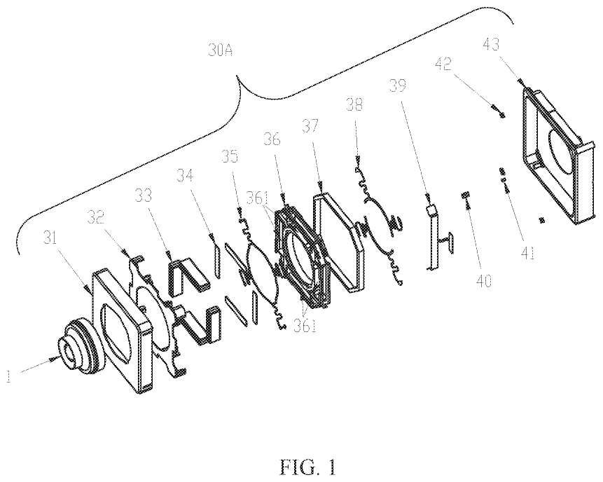

FIG. 1 is a diagram of an automatic focusing mechanism 30A in a camera device 100 according to an embodiment of the present invention;

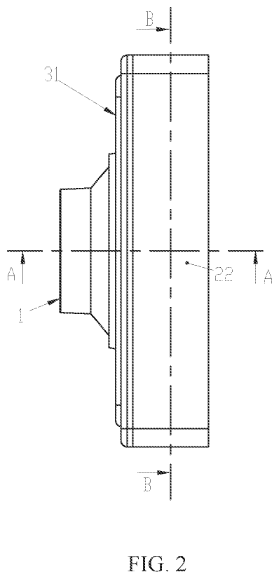

FIG. 1 to FIG. 14 illustrate a camera device 100 and elements included in the camera device 100 according to an embodiment of the present invention.

The camera optical system of the camera device 100 includes a lens 1, an automatic focusing mechanism 30A for driving the lens 1 to perform automatic focusing, and a stabilization mechanism 10A including a camera element unit 2.

In the conventional automatic focusing mechanism, the lens and the camera element unit has a small size, so the lens holder is required to be as small as possible, so that a position of the drive magnet for auto-focusing is arranged at a side where a case for auto-focusing is located. In this structure, the magnetic flux of the drive magnet for auto-focusing is divergent, and the magnetic flux efficiency is low. Therefore, it cannot effectively act on an electromagnetic force generated by the drive coil for auto-focusing after being energized, and the driving force efficiency is not high.

Due to a large size of the camera element unit 2, there is enough space for the lens holder 36, so that the lens holder 36 has a larger volume, and there is more space to accommodate the drive magnet 33 for auto-focusing. Therefore, it is possible to arrange the drive magnet 33 for auto-focusing at a side closer to an optical axis than the coil 37 for auto-focusing.

As shown in FIG. 1 to FIG. 14, the automatic focusing mechanism 30A of the camera device 100 includes a case 31 for auto-focusing, a magnet holding frame 32 for auto focus, a drive magnet 33 for auto-focusing, a yoke 34 for auto-focusing, an upper leaf spring 35 for auto-focusing, a lens holder 36, a drive coil 37 for auto-focusing, a lower leaf spring 38 for auto-focusing, an FPC 39 for auto-focusing, a magnet 40 for position detection for auto-focusing, a Hall element 41 for auto-focusing, an anti-vibration gel 42 for auto-focusing, a base 43 for auto-focusing.

An embodiment of the present invention provides a camera device 100. As shown in FIG. 1 to FIG. 14, it includes a lens 1 having an optical axis 3, and an automatic focusing mechanism 30A that drives the lens 1 to move along a direction of the optical axis 3. The automatic focusing mechanism 30A includes a fixed part, a movable part, and an elastic assembly connecting the fixed part and the movable part. The fixed part includes a case 31 for auto-focusing with magnetism, a drive magnet 33 for auto-focusing fixed to the case 31 for auto-focusing, and a base 43 for auto-focusing. The case 31 for auto-focusing and the base 43 for auto-focusing form a receiving space 46. The movable part includes a lens holder 36, and a drive coil 37 for auto-focusing fixed to the lens holder 36. The movable part is received in the receiving space 46. In a plane perpendicular to the optical axis 3, the drive magnet 33 for auto-focusing is arranged at a side of the drive coil 37 for auto-focusing close to the optical axis 3, and the drive coil 37 for auto-focusing is arranged inside a closed magnetic circuit 44 formed by the drive magnet 33 for auto-focusing and the case 31 for auto-focusing.

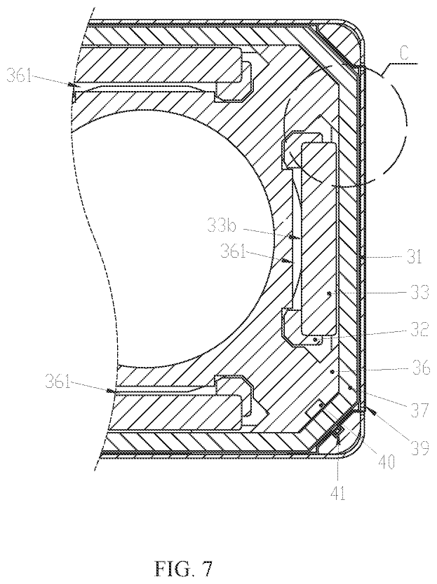

As shown in FIG. 1, FIG. 6 and FIG. 7, four drive magnets 33 for auto-focusing are provided, and the lens holder 36 is provided with four through-holes 361 parallel to the optical axis. The drive magnets 33 for auto-focusing are received in the through-holes 361.

As shown in FIG. 6 and FIG. 7, the magnet holding frame 32 for auto-focusing is fixed to a side of the case 31 for auto-focusing close to the base 43 for auto-focusing, and the drive magnet 33 for auto-focusing is fixed to the magnet holding frame 32 for auto-focusing. The drive magnet 33 is arranged is arranged closer to a center of the optical axis 3 than the drive coil 37 for auto-focusing. The drive coil 37 for auto-focusing is arranged between the closed magnetic circuit 44 formed by the drive magnet 33 for auto-focusing and the case 31 for auto-focusing. The FPC 39 for auto-focusing supplies power to the drive coil 37 for auto-focusing through the lower leaf spring 38 for auto-focusing.

As shown in FIG. 1 and FIG. 6, the elastic assembly includes an upper leaf spring 35 for auto-focusing and a lower leaf spring 38 for auto-focusing, and is received in receiving space 46. The upper leaf spring 35 for auto-focusing is arranged between the lens holder 36 and the magnet holding frame 32 for auto-focusing, and is connected to the lens holder 36 and the magnet holding frame 32 for auto-focusing. The lower leaf spring 38 for auto-focusing is arranged between the lens holder 36 and the base 43 for auto-focusing, and is connected to the lens holder 36 and the base 43 for auto-focusing. Four corners of the lower leaf spring 38 for auto-focusing are connected to the magnet holding frame 32 for auto-focusing. The upper leaf spring 35 for auto-focusing and the lower leaf spring 38 for auto-focusing can keep the lens 1 in a suspended state by the respective elasticity in an unactuated state of the automatic focusing mechanism 30A.

Further, as shown in FIG. 7, a Hall element 41 for auto-focusing is installed to the FPC 39 for auto-focusing to detect the magnetic flux of the magnet 40 for position detection for auto-focusing, so that the position of the lens holder 36 can be fed back, thereby allowing the automatic focusing mechanism 30A to perform automatic focusing.

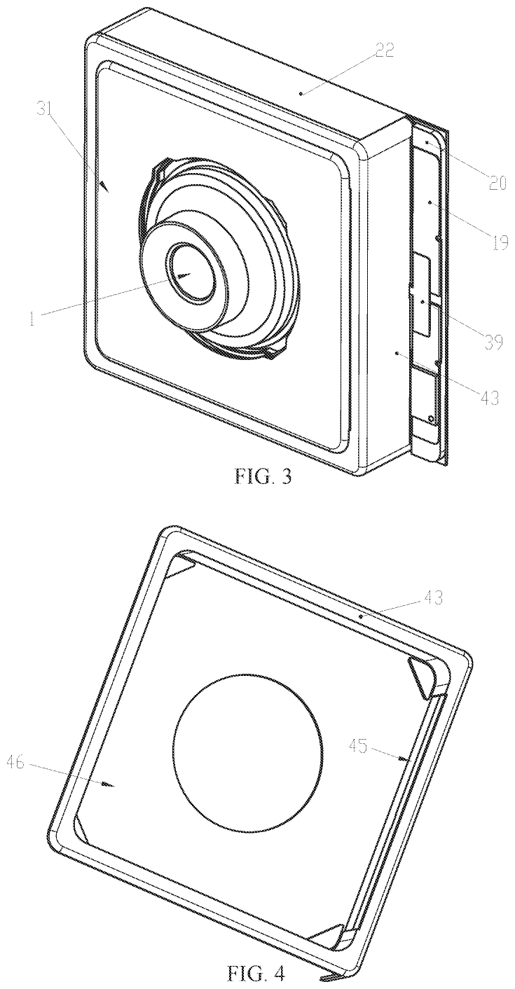

As shown in FIG. 1, FIG. 3, and FIG. 4, an opening 45 for passing the FPC 39 for auto-focusing to the outside is provided at a bottom surface of the base 43 for auto-focusing, and the FPC 39 for auto-focusing is fixed to the magnet holding frame 32 for auto-focusing, and at least partially extends outside the base 43 for auto-focusing through the opening 45.

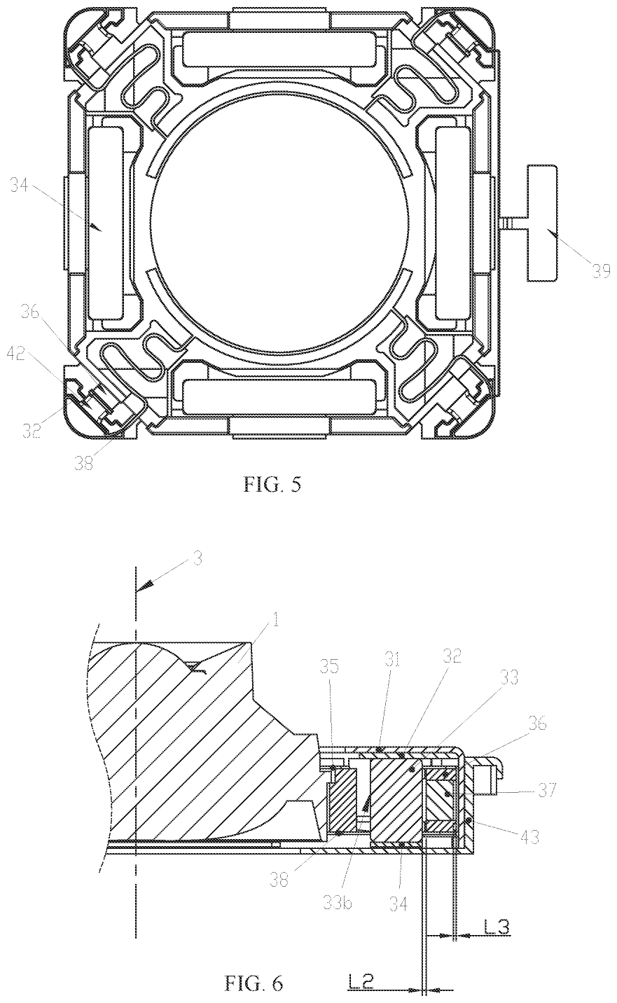

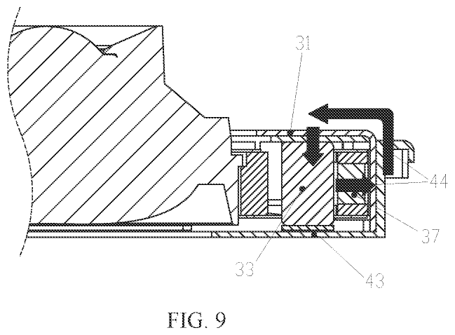

As shown in FIG. 5, FIG. 6 and FIG. 9, the yoke 34 for auto-focusing is located at the base 43 for auto-focusing, and along a direction parallel to the optical axis 3, an upper end and a lower end of the drive magnet 33 for auto-focusing respectively abuts against the magnet holding frame 32 for auto-focusing and the yoke 34 for auto-focusing.

As shown in FIG. 5, along a plane perpendicular to the optical axis 3, the anti-vibration gel 42 for auto-focusing is provided between the magnet holding frame 32 for auto-focusing and the lens holder 36, and it can have a more accurate autofocus function by generating a vibration damping effect against a sudden power-on control pulsation action of the autofocus.

As shown in FIG. 6 and FIG. 9, by providing the drive coil 37 for auto-focusing in the closed magnetic circuit 44 formed by the case 31 for auto-focusing and the drive magnet 33 for auto-focusing, the magnetic flux efficiency of the closed magnetic circuit 44 in this structure is high, so that it can effectively act on the electromagnetic force generated by the drive coil 37 for auto-focusing after being energized, thereby improving the driving force efficiency.

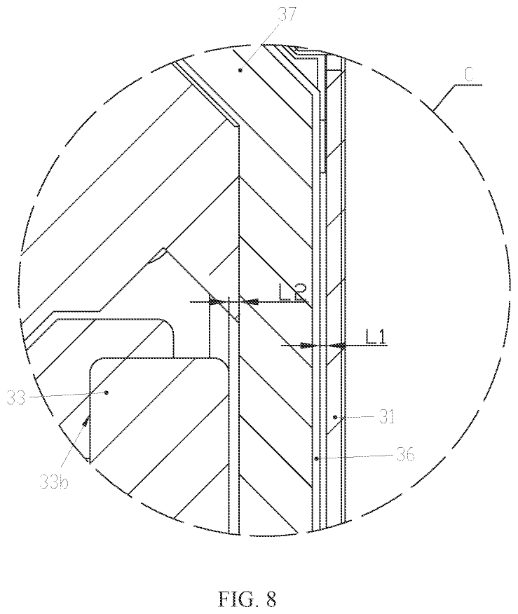

In an embodiment, as shown in FIG. 7 and FIG. 8, a distance L1 between the side of the case 31 for auto-focusing and a side of the lens holder 36 is shorter than a distance L2 between a side of the drive magnet 33 for auto-focusing and a side of the drive coil 37 for auto-focusing. In this case, even if the camera device 100 is impacted from the outside, a surface of the magnet 33 for auto-focusing does not come into contact with other components, thereby improving a dust-proof performance.

In an embodiment, as shown in FIG. 6, when the distance L2 between the side of the drive magnet for auto-focusing and the side of the drive coil for auto-focusing is compared with to conventional case where the drive magnet is provided outside the drive coil, since there is a redundant length L3 of the coil after the drive coil 37 for auto-focusing is installed, the drive magnet 33 for auto-focusing can get close to the drive coil 37 for auto-focusing, thereby improving the driving force efficiency of the automatic focusing mechanism 30A.

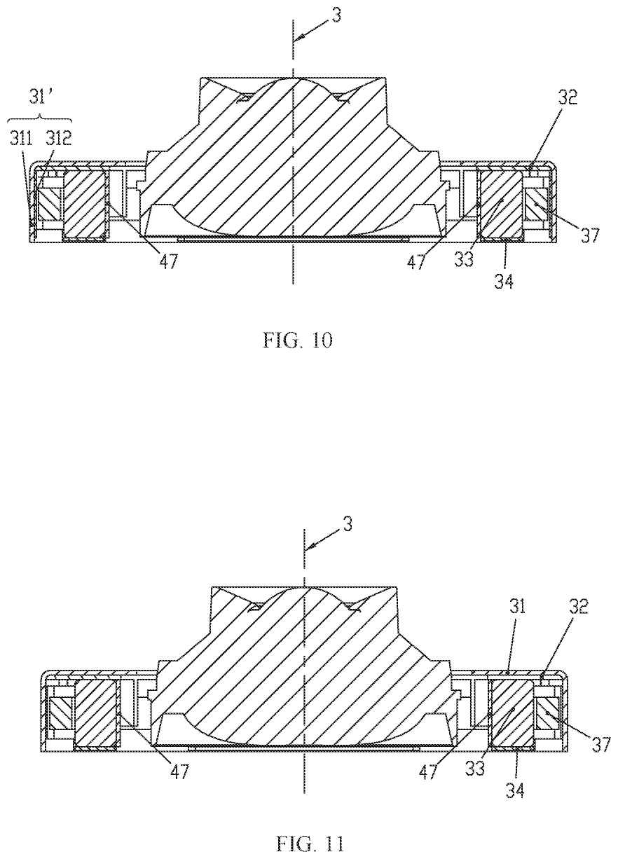

In an embodiment, as shown in FIG. 10, the case 31′ for auto-focusing is made of a non-magnetic material. The case 31′ for auto-focusing includes a case body 311 and a case yoke 312 attached to an inner side of case body 311, which can avoid magnetic flux divergence of the magnet 33 for auto-focusing, thus forming a closed loop with the drive magnet 33 for auto-focusing and improving the magnetic flux efficiency. In an embodiment, when the case 31 for auto-focusing is made of a non-magnetic material, an enhancement yoke 47 is provided at a side 33b of the optical axis of the drive magnet for auto-focusing, thereby improving the magnetic flux efficiency.

In an embodiment of the present invention, as shown in FIG. 9, the case 31 for auto-focusing is made of magnetic material and is a magnetic case, so a closed magnetic circuit can be formed between the drive magnet 33 for auto-focusing and the case 31 for auto-focusing. In this case, there is no need to provide a yoke inside the case 31 for auto-focusing, and a space occupied by the drive magnet 33 for auto-focusing and the drive coil 37 for auto-focusing can be reduced, thereby reducing a volume of the drive element of the automatic focusing mechanism 30A.

In another embodiment, as shown in FIG. 11, when the case 31 for auto-focusing is made of a magnetic material, an enhancement yoke 47 can be provided at a side 33b of the optical axis of the drive magnet for auto-focusing to improve the magnetic flux efficiency.

Since the drive coil 37 for auto-focusing is arranged away from the lens 1, a performance degradation of the lens 1 caused by the electric heating of the drive coil 37 for auto-focusing can be alleviated, thereby improving the optical performance.

By adopting the above-described structure, that is, a structure in which the automatic focusing mechanism 30A includes the case 31 for auto-focusing, and the drive coil 37 for auto-focusing is installed between the closed magnetic circuit 44 formed by the magnetic case 31 for auto-focusing and the drive magnet 33 for auto-focusing close to a center of the optical axis 3, a compact, small-height, and easy-to-assemble camera device 100 can be obtained. Besides, with this structure, an influence of heat generation on the lens 1 can be minimized without using other independent components.

The drive element of the automatic focusing mechanism 30A may be a voice coil motor.

The present invention provides the following three control structures for the automatic focusing mechanism 30A.

In a first control structure, the movable part is provided with a magnet 40 for position detection for auto-focusing, and the fixed part is provided with a Hall element 41 for auto-focusing. This structure can be used for open-loop control of the automatic focusing mechanism 30A. The Hall element 41 for auto-focusing is configured to detect the magnetic flux of the magnet 40 for position detection for auto-focusing, so that the position of the lens holder 36 can be obtained. Automatic focusing can be achieved by current controlling the automatic focusing mechanism 30A.

In an embodiment shown in FIG. 1 and FIG. 7, the magnet 40 for position detection for auto-focusing is installed to the lens holder 36 of the movable part, and the Hall element 41 for auto-focusing is installed to the FPC for auto-focusing.

In a second control structure, the movable part is provided with a Hall element 41 for auto-focusing, and the fixed part of the automatic focusing mechanism 30A is provided with a magnet 40 for position detection for auto-focusing. This structure can also be used for open-loop control of the automatic focusing mechanism 30A. The Hall element 41 for auto-focusing is configured to detect the magnetic flux of the magnet 40 for position detection for auto-focusing, so that the position of the lens holder 36 can be obtained. Automatic focusing can be achieved by current controlling the automatic focusing mechanism 30A.

In a third control structure, the camera device 100 includes a driver IC 18, and the driver IC can control a position of the movable part of the automatic focusing mechanism 30A. This structure is used for closed-loop control of the automatic focusing mechanism 30A. The driver IC 18 can detect a position of the lens holder 36. According to the position of the lens holder 36, the driver IC 18 can directly control the position of the movable part to achieve automatic focusing.

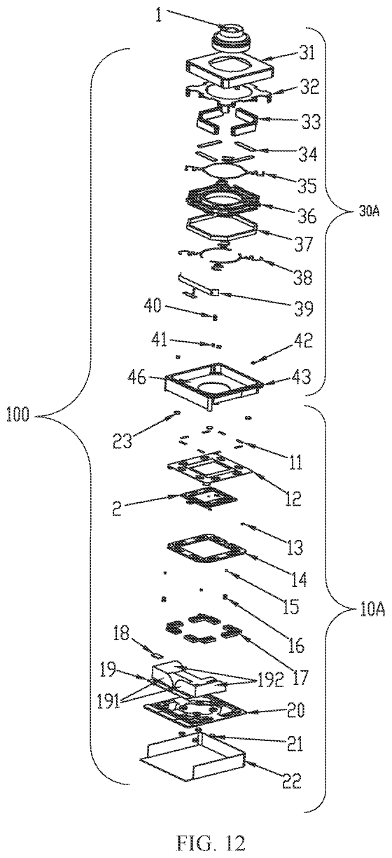

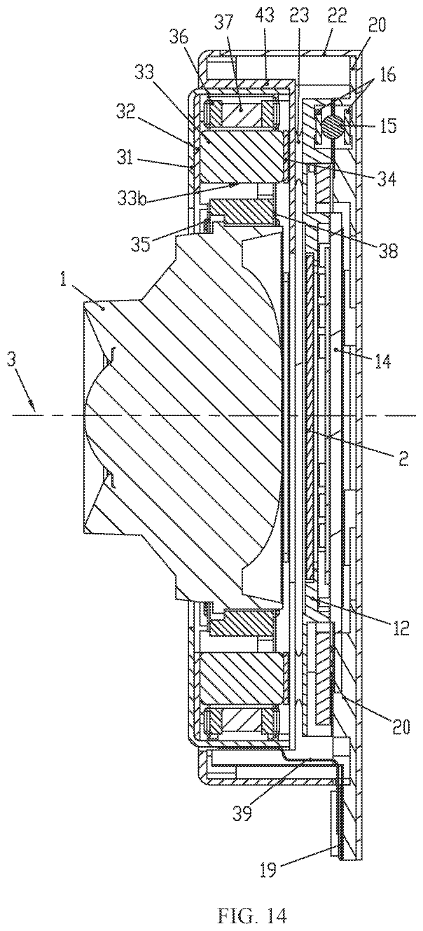

As shown in FIG. 12 to FIG. 14, the stabilization mechanism 10A for the camera device fitted with the automatic focusing mechanism 30A includes a base 20 for the stabilization mechanism. As shown in Fi. 12 and FIG. 14, the base 20 for the stabilization mechanism is arranged at the case 22 for the stabilization mechanism, and is fixed together with the magnet 17 for the stabilization mechanism and the support plate 16 of the support component for the stabilization mechanism.

As shown in FIG. 12 to FIG. 14, the camera element unit 2, the coil 14 for the stabilization mechanism, the support plate 16 of the support component for the stabilization mechanism, and the yoke 11 for the stabilization mechanism are all fixed to the movable frame 12 for the stabilization mechanism.

The movable part including the camera element unit 2 is supported by the support component 15 for the stabilization mechanism and can be freely driven on a plane perpendicular to the optical axis 3.

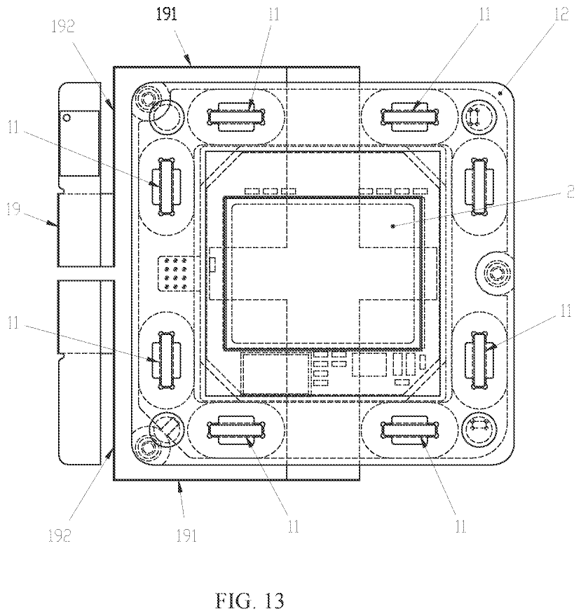

In an embodiment, as shown in FIG. 13, the movable frame 12 for the stabilization mechanism is an integrated frame, which integrates a protective component for protecting the camera element unit 2 and a frame of an optical filter, and is configured to protect the camera element unit 2 and receive an infrared cut-off filter that blocks harmful wavelengths. The configuration of the movable frame 12 for the stabilization mechanism can reduce the used components, and can improve the verticality of the camera element unit 2 relative to the optical axis 3, thereby reducing an inclination of the camera element unit 2 relative to the optical axis 3 and reducing a change in the flatness of the camera element unit 2. In this way, an overall rigidity of the camera element unit 2 and the protection against drop impact can be improved, which not only contributes to miniaturization and height reduction, but also improves the convenience of assembling process and the performance of the entire stabilization mechanism 10A.

In an embodiment, as shown in FIG. 12, at least two Hall elements 13 for the stabilization mechanism are installed to the coil 14 for the magnet 17 for the stabilization mechanism. By detecting the magnetic flux of the fixed magnet 17 for the stabilization mechanism, accurate position detection and stabilization control of the stabilization mechanism 10A can be performed.

As shown in FIG. 12 and FIG. 13, the Hall element 13 for the stabilization mechanism, the coil 14 for the stabilization mechanism, the signal line and the power supply of the camera element unit 2, etc. can be arranged at the outside of the stabilization mechanism 10A by means of the FPC 19 for the stabilization mechanism, so that these components do not interfere with the movement of the stabilization mechanism 10A.

As shown in FIG. 12 and FIG. 13, the FPC 19 for the stabilization mechanism is provided with a space for free movement between the case 22 for the stabilization mechanism and the base 43 for auto-focusing. In an embodiment, the FPC for the stabilization mechanism is provided with at least a curved surface A191 of the FPC for the stabilization mechanism and a curved surface B192 of the FPC for the stabilization mechanism, so as to form a structure that does not interfere with the movement of the movable part on the plane.

By energizing the coil 14 for the stabilization mechanism installed to the movable frame 12 for the stabilization mechanism, an electromagnetic field is generated, thereby efficiently generating an electromagnetic force relative to the magnet 17 for the stabilization mechanism. In this way, the coil 14 for the stabilization mechanism can move freely in the plane perpendicular to the optical axis 3, thereby preventing vibration.

In the stabilization mechanism 10A, as shown in FIG. 12 and FIG. 13, the yoke 11 for the stabilization mechanism is installed to the movable frame 12 for the stabilization mechanism, and can be attracted toward a center by the relatively fixed magnet 17 for the stabilization mechanism. The camera element unit 2 has a magnetic spring effect that is always attracted toward a center of the optical axis 3 by the yoke 11 for the stabilization mechanism and the magnet 17 for the stabilization mechanism. In addition, the camera element unit 2 has a magnetic spring effect that can be horizontally attracted to the optical axis 3 with respect to the magnet 17 for the stabilization mechanism, therefore, a gap can be efficiently eliminated, and a degree of inclination of the camera element unit 2 with respect to the optical axis 3 can be reduced.

As shown in FIG. 14, a bearing surface of a support plate 16 of a support component for the stabilization mechanism installed to the movable frame 12 for the stabilization mechanism and a bearing surface of a support plate 16 of a support component for the stabilization mechanism installed to the base 20 for the stabilization mechanism each have a surface accuracy, so that the support component 15 for the stabilization mechanism can rotate smoothly.

As shown in FIG. 12 and FIG. 13, while the yoke 11 for the stabilization mechanism moves toward the center, the movable frame 12 for the stabilization mechanism, the base 20 for the stabilization mechanism and the support component 15 for the stabilization mechanism can be prevented from dropping. Moreover, the leakage magnetic flux of the coil 14 for the stabilization mechanism can be effectively used as a driving force, so that the number of parts can be greatly reduced.

In an embodiment, as shown in FIG. 12 and FIG. 14, an upper portion of the movable frame 12 for the stabilization mechanism is coated with a vibration damping gel A23 for the stabilization mechanism, which has a vibration damping effect. In this way, the fluctuations generated when the stabilization mechanism 10A is suddenly energized can be controlled, so that it has a more precise stabilization effect.

As shown in FIG. 12, the vibration damping gel for the stabilization mechanism may be a gel B21 for the stabilization mechanism coated between the base 20 for the stabilization mechanism and the case 22 for the stabilization mechanism. Likewise, it also has a vibration damping effect. In this way, the fluctuations generated when the stabilization mechanism 10A is suddenly energized can be controlled, so that it has a more precise stabilization effect.

The coil 14 for the stabilization mechanism may be a structure with a plurality of single coil windings, or may be a conductive pattern formed on the FPC 19 for the stabilization mechanism according to a shape of the coil 14 for the stabilization mechanism.

By combining the automatic focusing mechanism 30A and the stabilization mechanism 10A, automatic focusing and stabilization of the camera element unit 2 can be achieved.

The stabilization mechanism 10A can be driven in a rotation direction of the optical axis 3 by making the directions of the currents flowing into the coil 14 of the stabilization mechanism at both sides opposite, and it can also be used as an anti-rotation/anti- deflection mechanism (not shown).

Therefore, with the above-mentioned stabilization mechanism 10A, four-axis autofocus and stabilization mechanism can be achieved.

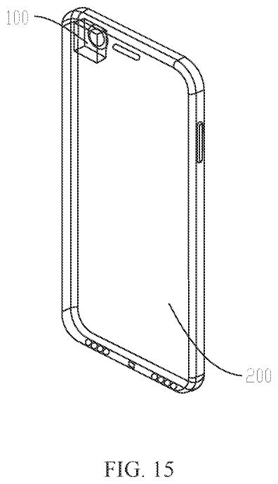

The camera device 100 described above can be used for the portable electronic device 200 shown in FIG. 15, for example, a portable electronic device such as a smart phone, a feature phone, or a tablet device.

The above description merely illustrates some embodiments of the present invention. It should be noted that for those skilled in the art, improvements may be made without departing from an inventive concept of the present invention, but all of these improvements shall belong to a scope of present invention.

What is claimed is:

1. A camera device, comprising:
a lens having an optical axis; and
an automatic focusing mechanism configured to drive the lens to move along a direction of an optical axis, wherein the automatic focusing mechanism comprises:
a fixed part comprising a magnetic case for auto-focusing, at least one drive magnet for auto-focusing fixed to the case for auto-focusing, and a base for auto-focusing;
a movable part comprising a lens holder, and a drive coil for auto-focusing fixed to the lens holder; and
an elastic assembly that connects the fixed part and the movable part,
wherein a receiving space is formed by the case for auto-focusing and the base for auto-focusing, and the movable part is received in the receiving space,
wherein in a plane perpendicular to the optical axis, the drive magnet for auto-focusing is arranged at a side of the drive coil for auto-focusing close to the optical axis, and the drive coil for auto-focusing is arranged in a closed magnetic circuit formed by the at least one drive magnet for auto-focusing and the case for auto-focusing.

2. The camera device as described in claim 1, wherein the at least one drive magnet for auto-focusing comprises four drive magnets for auto-focusing, the lens holder is provided with four through-holes penetrating along a direction parallel to the optical axis, and the four drive magnets for auto-focusing are received in the four through-holes.

3. The camera device as described in claim 1, further comprising a magnet holding frame for auto-focusing which is fixed to a side of the case for auto-focusing close to the base for auto-focusing, wherein the at least one drive magnet for auto-focusing is fixed to the magnet holding frame for auto-focusing.

4. The camera device as described in claim 3, further comprising a yoke for auto-focusing provided at the base for auto-focusing, wherein in a direction parallel to the optical axis, upper and lower ends of the at least one drive magnet for auto-focusing respectively abut against the magnet holding frame for auto-focusing and the yoke for auto-focusing.

5. The camera device as described in claim 1, wherein the case for automatic focusing is made of a magnetic material.

6. The camera device as described in claim 1, wherein the case for auto-focusing comprises a case body and a case yoke attached to an inner side of the case body, and the case body is made of a non-magnetic material.

7. The camera device as described in claim 1, further comprising an enhancement yoke provided at a surface of the at least one drive magnet for auto-focusing close to the optical axis.

8. The camera device as described in claim 1, wherein one of the movable part and the fixed part is provided with a magnet for position detection for auto-focusing, and the other one of the movable part and the fixed part is provided with a Hall element for auto-focusing.

9. The camera device as described in claim 1, further comprising a driver IC, wherein the driver IC controls a position of the movable part.

10. The camera device as described in claim 1, wherein a distance between a side of the case for auto-focusing and a side of the lens holder is a first distance L1, and a distance between a side of the at least one drive magnet for auto-focusing and a side of the drive coil for the auto-focusing is a second distance L2 larger than the first distance L1.

11. The camera device as described in claim 1, further comprising a stabilization mechanism.

12. The camera device as described in claim 11, wherein the stabilization mechanism is arranged at an imaging side of the automatic focusing mechanism.

13. A portable electronic device, comprising a camera device, wherein the camera device comprises:
a lens having an optical axis; and
an automatic focusing mechanism configured to drive the lens to move along a direction of an optical axis, wherein the automatic focusing mechanism comprises:
a fixed part comprising a magnetic case for auto-focusing, at least one drive magnet for auto-focusing fixed to the case for auto-focusing, and a base for auto-focusing;
a movable part comprising a lens holder, and a drive coil for auto-focusing fixed to the lens holder; and
an elastic assembly that connects the fixed part and the movable part,
wherein a receiving space is formed by the case for auto-focusing and the base for auto-focusing, and the movable part is received in the receiving space,
wherein in a plane perpendicular to the optical axis, the drive magnet for auto-focusing is arranged at a side of the drive coil for auto-focusing close to the optical axis, and the drive coil for auto-focusing is arranged in a closed magnetic circuit formed by the at least one drive magnet for auto-focusing and the case for auto-focusing.
